(19) United States
(12) Patent Application Publication
(10) Pub. No.: US 2016/0142625 A1
(43) Pub. Date: May 19, 2016

(54) METHOD AND SYSTEM FOR DETERMINING IMAGE COMPOSITION ATTRIBUTE ADJUSTMENTS

(71) Applicant: Lenovo (Singapore) Pte. Ltd., New Tech Park (SG)

(72) Inventors: Arnold S. Weksler, Raleigh, NC (US); Neal Robert Caliendo, JR., Raleigh, NC (US)

(21) Appl. No.: 14/540,654

(22) Filed: Nov. 13, 2014

(51) Int. Cl. H04N 5/232; G06F 17/30; G06K 9/00; G06T 7/00; H04L 29/08; H04W 4/02

(52) U.S. Cl. CPC H04N 5/23222; H04L 67/18; H04L 67/22; H04W 4/021; G06K 9/00201; G06K 9/00624; G06T 7/003; G06F 17/30256

(57) ABSTRACT

Method, system and program product are provided for collecting image information for a scene in a field of view with a camera, and obtaining a candidate attribute of interest (AOI) associated with the image information. The method and program product identify a reference AOI associated with a reference image corresponding to the image information, determine an AOI adjustment indicative of a change in the candidate AOI in order to align the candidate AOI with the reference AOI, and output the AOI adjustment.

### BACKGROUND

Embodiments of the present disclosure generally relate to methods and systems to determine attribute adjustments when photographing or video recording scenes.

Today, cameras include various features to automatically control the settings for the camera. For example, cameras automatically focus on objects in the field of view, remove “red” eyes from individuals in photos, and perform a number of other operations to automatically change the settings of the camera before taking pictures.

However, photographers still rely on their individual judgment and photography skills when choosing attributes beyond the automated settings of the camera. For example, each photographer chooses the viewpoint, time of day, angle of elevation, and a variety of other composition related attributes when framing a scene to photograph. Composition related attributes are somewhat subjective, depending on the preferences and skill of the photographer. As such, photographs of a common object or landmark by different individuals will greatly differ.

Often, amateur photographers are left feeling that their photographs of well-known (and commonly photographed) landmarks are not as “good” as photographs of the same landmark that are taken by professional photographers. For example, an amateur photographer may desire to take a family photograph with a popular landmark in the background, but when comparing the family photo to professional photographs of the same landmark, the user finds the landmark in the family photograph not as “pleasing” or impressive as in the professional photographs.

### SUMMARY

In accordance with an embodiment, a method is provided that comprises collecting image information for a scene in a field of view (FOV) with a camera, and obtaining a candidate attribute of interest (AOI) associated with the image information. The method also comprises identifying a reference AOI associated with a reference image corresponding to the image information. The method also comprises determining an AOI adjustment indicative of a change in the candidate AOI in order to align the candidate AOI with the reference AOI, and outputting the AOI adjustment.

Optionally, the method may determine the AOI adjustment based on a difference between the candidate and reference AOIs. Optionally, the method may further comprise collecting scene designation data uniquely identifying the scene, the reference AOI identified based on the scene designation data. Optionally, the scene designation may constitute metadata collected by the mobile device and saved with the image information.

Optionally, the scene designation data may comprise at least one of location data, date and time data, or landmark identification data. Optionally, the method may provide for the AOI adjustment to correspond to an adjustment for at least one of a rule of thirds, golden ratio, golden triangle, golden spiral, rule of odds, leaving space, fill the frame, simplification, balance, leading lines, patterns, color, texture, symmetry, viewpoint, background, depth, framing, orientation, contrast, layout, arrangement, image composition, view point, lighting, and/or camera settings.

In accordance with an embodiment, a computer program product is provided, that comprises a non-signal computer readable storage medium comprising computer executable code. The product collects image information for a scene in a field of view (FOV) with a camera, and obtains a candidate attribute of interest (AOI) associated with the image information. The product also identifies a reference AOI associated with a reference image corresponding to the image information. The product also determines an AOI adjustment indicative of a change in the candidate AOI in order to align the candidate AOI with the reference AOI, and outputs the AOI adjustment.

Optionally, the program product may provide for the analyzing operation to include segmenting the image information into one or more segmented objects and identify one or more candidate attributes of interest associated with each of the one or more segmented objects. Alternatively, the program product may provide to access a collection of reference images, and compare reference segmented objects in the reference images with the segmented objects from the image information to identify one or more of the reference images related to the image information.

In accordance with an embodiment, a system is provided, that comprises a processor, and a camera to collect image information for a scene in a field of view (FOV) of the camera. The system also comprises a storage medium storing program instructions accessible by the processor, and a user interface to output the AOI adjustment. The processor, responsive to execution of the program instructions, obtains a candidate attribute of interest (AOI) associated with the image information. The processor also receives a reference AOI associated with a reference image corresponding to the image information. The processor also determines an AOI adjustment indicative of a change in the candidate AOI in order to align the candidate AOI with the reference AOI.

Optionally, the system may be configured wherein the camera unit obtains, as the image information, image framing information representing at least one of i) a select region of the scene in the field of view or ii) a restricted resolution image of the scene in the field of view. Alternatively, the system may provide for the processor to determine the AOI adjustment based on a difference between the candidate and reference AOIs. Optionally, the system may further comprise a GPS tracking circuit to collect scene designation data uniquely identifying the scene, the reference AOI identified based on the scene designation data.

Optionally, the system may be configured wherein the storage medium saves the scene designation data as metadata associated with the image information. Optionally, the system may further comprise a server and a storage medium located remote from the camera, the storage medium storing a collection of reference images, the camera to collect scene designation data, the server to identify the reference image from the collection of reference images based on the scene designation data.

### BRIEF DESCRIPTION OF THE DRAWINGS

FIG. 1 illustrates a system formed in accordance with embodiments herein.

FIG. 2A illustrates a more detailed block diagram of the device of FIG. 1 in accordance with embodiments herein.

FIG. 2B illustrates a functional block diagram illustrating a schematic configuration of a camera unit that may be implemented as, or in place of, the camera unit of FIG. 1 in accordance with embodiments herein.

FIG. 3 illustrates a process carried out in accordance with embodiments for determining suggested adjustments to the composition of a photograph or video.

FIG. 4 illustrates a process for determining suggested adjustments based on image analysis in accordance with embodiments herein.

FIG. 5 illustrates a process to identify a subset of reference images from a collection of the reference images based on image ratings in accordance with embodiments herein.

FIG. 6 illustrates a user interface that may be implemented on the device in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

### System Overview

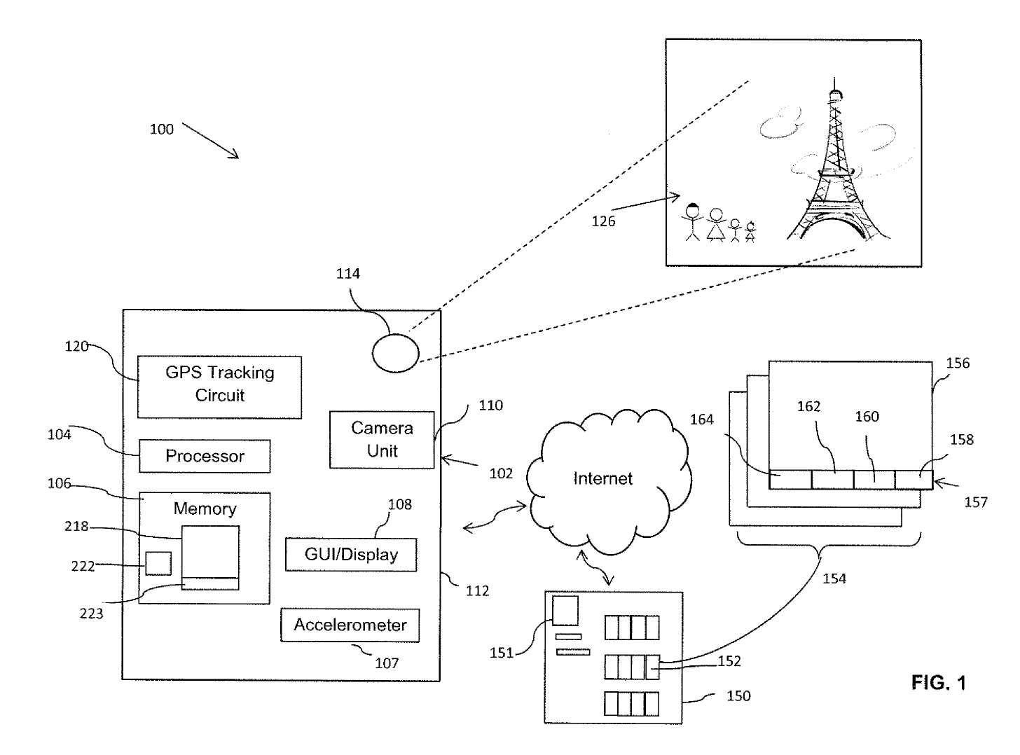

FIG. 1 illustrates a system 100 formed in accordance with embodiments herein. The system 100 includes a device 102 that may be mobile, stationary or portable handheld. The device 102 includes, among other things, a processor 104, local storage medium 106, and a graphical user interface (GUI) (including a display) 108. The device 102 also includes a digital camera unit 110 and a GPS tracking circuit 120. The device 102 includes a housing 112 that holds the processor 104, local storage medium 106, GUI 108, digital camera unit 110 and GPS tracking circuit 120. The housing 112 includes at least one side, within which a lens 114 may be mounted. The lens 114 is optically and communicatively coupled to the digital camera unit 110. The lens 114 has a field of view 122 and operates under control of the digital camera unit 110 in order to collect photographs, record videos, collect image information and the like for a scene 126.

The system 100 also includes a server 150 that includes storage medium 152 that stores a collection 154 of reference images 156. Each of the reference images 156 may include metadata 157 that includes reference scene designation data 158. The reference scene designation data may represent geographic location information and/or a name identifying the scene or object(s) in the scene. Each of the reference images 156 also includes one or more reference attributes of interest 160 stored there with, such as in the metadata 157. Alternatively or additionally, the reference scene designation data 158 and/or the reference attributes of interest 160 may be stored separate from the reference images, but uniquely associated there with.

In accordance with embodiments herein, device 102 determines suggested adjustments for image attributes of interest when photographing and/or videoing scenes. When a user begins/attempts to take a photograph and/or video recording of a scene, image information 218 is collected in connection with the scene 126. Often scenes include or correspond to a known object (e.g. a mountain, castle, known landmark). The device 102 (or separate server 150) compares the image information 218 to one or more reference images from a collection 154 of reference images 156 for the same known object/scene. The comparison may be performed real-time while the user is framing a scene in the field of view of the camera and preparing to capture the photograph/recording. Optionally, the comparison may be performed after a photograph/recording is taken, where all or a portion of the photograph or recording is used as the image information 218. For example, a first photograph may be taken and analyzed as explained herein. Thereafter, AOI adjustments may be presented to the user as suggestions (also referred to throughout as instructions or user instructions) to change the composition and then a second photograph/video taken.

The collection 154 of reference images 156 has reference attributes of interest 160 stored therewith. For example, the attributes of interest may represent various aspects of an image's composition, such as viewpoint, lighting, camera settings, as well as various other attributes discussed herein and known. One or more AOI adjustments are derived by comparing the reference attributes of interest 160 to “candidate” attributes of interest 222 associated with the photograph/recording that the user is beginning/attempting to take. As a non-limiting example, the AOI adjustment may include changing the viewpoint (e.g. to instruct the user to aim the field of view lower or higher, to move the field of view to the left or right and the like). As another non-limiting example, the AOI adjustment may include changing the time of day (e.g., to sunset, sunrise) at which the photograph is taken, as well as making changes to the time of day, viewpoint and the like based on harsh shadows or sunlight conditions detected within the image information 218. The AOI adjustment may also factor whether the day is sunny or clouding, the time of year (e.g., winter, summer). As another non-limiting example, the AOI adjustment may include changing the focal length or closeness/distance to the object.

Alternatively or additionally, image ratings 162 may also be stored with the reference images 156, such as in the metadata 157 or elsewhere but associated with the reference images 156. The image ratings 162 are indicative of a quality of the corresponding reference images 156. The image ratings 162 may be utilized when more than one reference image 156 is stored in storage medium 152 for a common object or scene. The image ratings 162 may be utilized to obtain a desired (e.g. recommended) photograph/video from the reference images 156 to be used in the comparison to the new/candidate photograph/video that the user is beginning to take.

The metadata 157 may also include ancillary content 164, such as the existence of foreign items or obstructions in the object or scene, such as shadows, telephone poles, cars, people, other background items and the like. The ancillary content 164 in the metadata 157 may also include reviews and suggestions to reduce the number of foreign items or obstructions in the object or scene. Embodiments herein may utilize the ancillary content 164 to determine AOI adjustments. For example, the ancillary content 164 may indicate that undesirable background or foreground objects will appear in the scene when taken from a particular viewpoint. Accordingly, the AOI adjustment suggestion for the user maybe to move to the left or right of, move closer to, or move further away from, the object in the scene.

In the example of FIG. 1, the collection 154 of reference images 156 is saved on a server 150 remote from the device 102. The device 102 communicates with the server 150, as explained herein, to utilize the reference images 156 to obtain suggested adjustments in one or more attributes of interest for photographs and/or videos taken by the user. Optionally, the collection 154 of reference images 156 may be stored locally in the local storage medium 106 of the device 102, thereby rendering optional communication with the server 150 in real time while taking photographs or videos. Alternatively or additionally, a subset of the collection 154 of reference images 156 may be downloaded from the server 150 to the local storage medium 106. The subset of the collection 154 may be downloaded temporarily, or for an extended period of time or permanently, to the local storage medium 106. For example, when a user plans (or is on) a vacation, business trip, hike, picnic or other travel activity, the user may go online and download a select subset of the collection 154 that relates to the geographic region where the vacation, business trip or other travel activity is plan or ongoing. As a further non-limiting example, when the user plans a trip to New York City, reference images 156 associated with landmarks and other objects in New York City may be downloaded to the local storage medium 106 automatically based on an input from the user indicating the trip destination.

The device 102 includes a global positioning system (GPS) tracking circuit 120 to calculate the geographic coordinates of the device 102 at various times of interest, including but not limited to when the camera unit 110 collects image information 218. The GPS tracking circuit 120 includes a GPS receiver to receive GPS timing information from one or more GPS satellites that are accessible to the GPS tracking circuit 120. The GPS tracking circuit 120 may also include a cellular transceiver configured to utilize a cellular network when GPS satellites are not in line of sight view and/or to utilize the cellular network to improve the accuracy of the GPS coordinates.

The GPS tracking circuit 120 is a circuit that uses the Global Positioning System to determine a precise location of the device 102 to which it is attached and to record the position of the device 102 at regular intervals. The recorded geographic location data can be stored within the local storage medium 106, with the GPS tracking circuit 120, transmitted to a central location data base, or internet-connected computer, using a cellular (GPRS or SMS), radio, or satellite modem embedded in the GPS tracking circuit 120. The geographic location data allows the location of the device 102 to be determined in real time using GPS tracking software. The GPS tracking software may be provided within and implemented by the GPS tracking circuit 120, provided within local storage medium 106 and implemented on the processor 104), and/or provided on and implemented by the server 150.

During operation, a user positions and orients the device 102 such that the lens 114 is directed toward a scene 126 of interest, for which the user desires to take photographs or video. While the lens 114 is directed toward the scene 126, the camera unit 110 collects image information 218. The image information 218 may represent an actual photograph or video recording that is captured in response to the user entering a command to take the photo or start recording the video. Alternatively or additionally, the image information 218 may be collected by the camera unit 110 before the user enters a command to take a photo or recorded video, such as while undergoing a framing operation of the scene 126 within the field of view of the lens 114. For example, the framing operation may occur automatically by the camera unit 110 when the user activates the camera unit 110 (e.g., when the user opens a “Photo” or “Video” application on the device 102). During automatic framing, the camera unit 110 captures a frame or repeatedly captures frames of the scene periodically, such as each time the camera unit 110 performs an autofocus operation. For example, each time the camera unit 110 focuses, a “frame” may be captured. The image information 218 captured during a framing operation may include the same or less content as the content captured in a photograph or video. For example, the image information 218 collected during a framing operation may represent a “lower” resolution image as compared to the full resolution capability of the camera unit 110. Alternatively or additionally, the image framing information 218 collected during a framing operation may be limited to select regions of the field of view of the lens 114. For example, the image framing information 218 may be collected at full resolution (e.g., a common resolution as photographs), but only for a select portion of the field of view (e.g., the horizontal and vertical middle half or third of the field of view). The camera unit 110 may continuously collect image framing information 218 while the user performs the framing operation.

The attributes of interest may represent camera setting-related attributes of interest and/or composition-related attributes of interest. The camera setting—related attributes of interest may include one or more of shutter speed, aperture size, black-and-white mode, various color modes, and other settings that are automatically or manually adjusted on a camera. By way of example, the composition-related attribute(s) of interest may include the rule of thirds, the golden ratio, golden triangle, golden spiral, rule of odds, leaving space, fill the frame, simplification, balance, leading lines, patterns, color, texture, symmetry, viewpoint, background, depth, framing, orientation, contrast, layout, arrangement and other compositional constructions or rules related to the content of the field of view. Various attributes of interest are discussed below. It is understood that variations in the following attributes of interest, or alternative attributes of interest, may be utilized in accordance with embodiments herein.

### Composition-Related Attributes

Embodiments described herein utilize various attributes of interest in connection with determining AOI adjustments that may be of interest to the user when composing a photograph or video. The following list of attribute interest is not to be viewed as all-encompassing, and instead alternative or additional attributes of interest may be utilized.

The basic theory of the rule of thirds is that the human eye tends to be more interested in images that are divided into thirds, with the subject falling at or along one of those divisions. For example, the camera display may provide a visual grid in the viewfinder to use to practice the rule of thirds. The visual grid divides the display with four lines into nine equal-sized parts. In accordance with embodiments herein, the AOI adjustment that is output may suggest to the user to shift the field of view of the camera such that the subject is at the intersection of the dividing lines. For example, when photographing a person, the adjustment may suggest to position the subject in the FOV at the right or left third of the frame rather than directly in the middle.

The “golden ratio” divides the scene into sections. Instead of being evenly spaced as in the rule of thirds, golden ratio lines are concentrated in the center of the frame, with roughly ⅜ths of the frame in the above part, 2/8ths in the middle and ⅜ths at the bottom. Optionally, “golden triangles” may also be used, such as when the image has segmented an object that has diagonal borders/boundaries. To align a scene based on “golden triangles,” the image is divided diagonally from corner to corner, then a line is drawn from one of the other corners until it meets the first line at a 90 degree angle. In accordance with embodiments herein, the AOI adjustment may suggest to place the segmented objects such that they fall within the resulting triangles.

The “golden spiral” is a compositional tool for use with segmented objects that have curving lines rather than straight ones. In accordance with embodiments herein, the AOI adjustment may suggest to place the segmented objects where a spiral leads the eye to a particular point in the image.

The “rule of odds” is somewhat related to the rule of thirds. The eye tends to be more comfortable with images that contain an odd number of elements rather than an even number. A photograph of three birds on a wire, for example, may be more appealing than an image shot after that third bird flies away. The reason for this is that the human eye will naturally wander towards the center of a group. If there's empty space there, then that's where the eye will fall.

The “leaving space” rule incorporates two very similar ideas: breathing room and implied movement. To make a subject comfortable, the adjustment may suggest to give the subject a bigger box that allows the subject visual freedom and/or freedom of movement. If a subject is looking at something (even something off-camera), the AOI adjustment may suggest to provide “white space” in the scene for the subject to look into. White space, of course, is not a literal term but a term used to describe the space that surrounds a subject, usually that part of the frame where nothing is happening.

The “fill the frame” rule is different than crowding the frame. The “fill the frame” rule simply means that, when the scene includes distracting background objects/elements, the AOI adjustment may suggest to change the field of view to crop out the distracting background objects/elements. In accordance with embodiments herein, the AOI adjustment may suggest that the user decide how important a subject is and then give the subject a ratio of the frame that is directly related to the subject's importance. For example, an image of a woman with interesting facial lines and features who is standing on a busy street corner will probably warrant filling the frame. But if the user wants to capture context—say that the woman is standing in the quirky second-hand shop she's owned for 50 years—the user may not want to use the “fill the frame” rule, in order to capture her with her environment instead.

The “simplification” rule indicates that simple images tend to be more appealing than complicated ones. This idea is similar to the previous “fill the frame rule,” in that the suggestion would be to get rid of distracting elements in the scene. To use this compositional rule, simply ask: does the element add to the composition. If it doesn't, the suggestion may be to get rid of it. In accordance with embodiments herein, the adjustment may suggest to recompose so that the element is no longer in the scene, such as by zooming in on the subject, using a wider aperture for a shallow depth of field and the like.

The “balance” rule may apply to a photo with a large subject positioned in the foreground at a sweet spot that may end up creating an image that looks tilted, or too heavy on one side. In accordance with embodiments herein, the AOI adjustment may suggest to place the segmented objects to create some balance by including a less important, smaller-appearing element in the background.

The rule of “leading lines” provides that the human eye is drawn into a photo along lines—whether they are curved, straight, diagonal or otherwise. A line—whether geometric or implied—can bring the viewer's eye into an image. If the scene doesn't have clear lines the adjustment may suggest to shift the scene to include something else to let the viewer know where to look. Diagonal lines may be useful in creating drama in a scene.

Patterns appear everywhere, in both man-made settings and in natural ones. Pattern can be very visually compelling to suggest harmony and rhythm, and things that are harmonious and rhythmic may afford a sense or order or peace. In accordance with embodiments herein, the AOI adjustment may suggest to place the segmented objects relative to one or more noticeable patterns in the scene.

Color is another composition construction that may be considered. Cool colors (blues and greens) can make the viewer feel calm, tranquil or at peace. Reds and yellows can invoke feelings of happiness, excitement and optimism. A sudden spot of bright color on an otherwise monochromatic background can provide a strong focal point. The use of color can dramatically change a viewer's perception of an image. In accordance with embodiments herein, the AOI adjustment may suggest to place the segmented objects to provide a color arrangement of interest.

Texture is another composition construction that may be considered. Texture is another way of creating dimension in a photograph. By zooming in on a textured surface—even a flat one—the texture can make it seem as if the photograph lives in three dimensions. Even a long shot of an object can benefit from texture—what's more visually interesting, a shot of a brand new boat sitting at a squeaky-clean doc, or a shot of an old fishing boat with peeling paint sitting in the port of a century-old fishing village. In accordance with embodiments herein, the AOI adjustment may suggest to place the segmented objects to emphasize texture.

Symmetry is another composition construction that may be considered. A symmetrical image is one that looks the same on one side as it does on the other. There are various ways to take advantage of symmetry, which can be found in nature as well as in man-made elements. First, look for symmetrical patterns that are in unexpected places. For example, one may not expect to find symmetry in a mountain range. When symmetry is present in a mountain range, it's worth capturing. Second, look for symmetrical patterns with strong lines, curves and patterns. In accordance with embodiments herein, the AOI adjustment may suggest to place the segmented objects to take advantage symmetry within the scene.

Viewpoint is another composition construction that may be considered. Viewpoint can dramatically change the mood of a photograph. An image of a child as an example. Shot from above, a photograph of a child makes her appear diminutive, or less than equal to the viewer. Shot from her level, the viewer is more easily able to see things from her point of view. In this case the viewer becomes her equal rather than her superior. Shooting the child from below may create a sense of dominance about the child. Perspective can also change the viewer's perception of an object's size. To emphasize the height of a tree, for example, shoot it from below, looking up. To make something seem smaller, shoot it from above, looking down. Viewpoint isn't just limited to high, low and eye-level of course—you can also radically change the perception of an object by shooting it from a distance or from close up. In accordance with embodiments herein, the AOI adjustment may suggest to position the segmented objects at a select viewpoint or perspective.

Perspective is how the photographer views the objects in the camera frame via the placement of the camera. For example, the same subject will have different perspectives when photographed at eye level, from above or from ground level. By varying the perspective you change the placement of the horizon line and you influence the audience's perception of the scene. For example, if a camera is placed at ground level to take a full-body photo of someone, and angled up to fill the frame with the subject, the subject will appear much more menacing, powerful and larger than if the camera was held at eye-level. Another way to look at differing perspective is to utilize camera positions that are atypical to what the human eye sees. Bird's eye views or extremely high angles change the dynamics of the composition.

Background is another composition construction that may be considered. If the background is busy and doesn't add anything to a composition, a suggestion may be made to try using a wider aperture so those distracting elements will become a non-descript blur. Alternatively, the suggestion may be to change the viewing angle or view point. In accordance with embodiments herein, the AOI adjustment may suggest to position the segmented objects with less, more or a different background.

Depth is another composition construction that may be considered. Depth is dependent on the type of image to be captured. In a landscape, for example, it may be desirable for everything to remain in focus. In a portrait, it may be desirable for the background to be out of focus. In accordance with embodiments herein, the adjustment may suggest to place the segmented objects to isolate a subject from his or her background, use a wide aperture. To include the background, the suggestion may be to use a smaller one. Depth can also be shown through other means. For example, the suggestion may be to include something in the foreground. Optionally, the suggestion may be to overlap certain elements as the human eye is used to seeing closer objects appear to overlap objects that are at a distance, and thus the scene will present information as depth.

Framing is another composition construction that may be considered. A natural frame can be a doorway, an archway—or the branches of a tree or the mouth of a cave. Simply put, a natural frame is anything that can be used en lieu of an expensive wood frame. In accordance with embodiments herein, the adjustment may suggest to place the segmented objects such that they use natural frames to isolate the subject from the rest of the image, leading the viewer's eyes straight to a select portion of the image.

Orientation is another composition construction that may be considered. For example, when a scene contains strong vertical lines, in accordance with embodiments herein, the adjustment may suggest to use a vertical orientation.

Contrast is another composition construction that may be considered. Contrast is another way to add dimension to an image. Lighting contrast is the difference between the lightest light and the darkest dark in a photograph. Manipulating this element, may extend the depth, the three-dimensional quality of a photograph. Contrast can also be used in shape and size to affect the intricacy of the photos.

The layout or arrangement is another composition construction that may be considered. The layout or arrangement of the image influences how visually effective or stimulating the photos. When composing the photo, in accordance with embodiments herein, the adjustment may seek a balance in the color, the lighting, and object placement within the frame's constricting rectangle.

### Image Capture Device

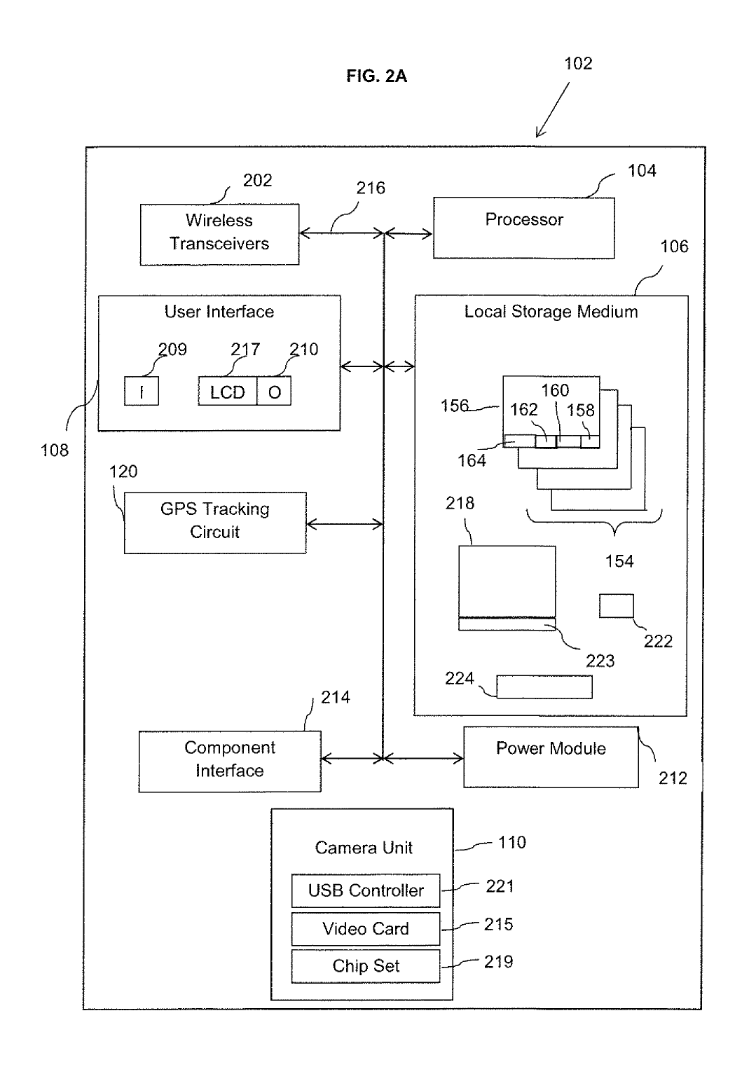

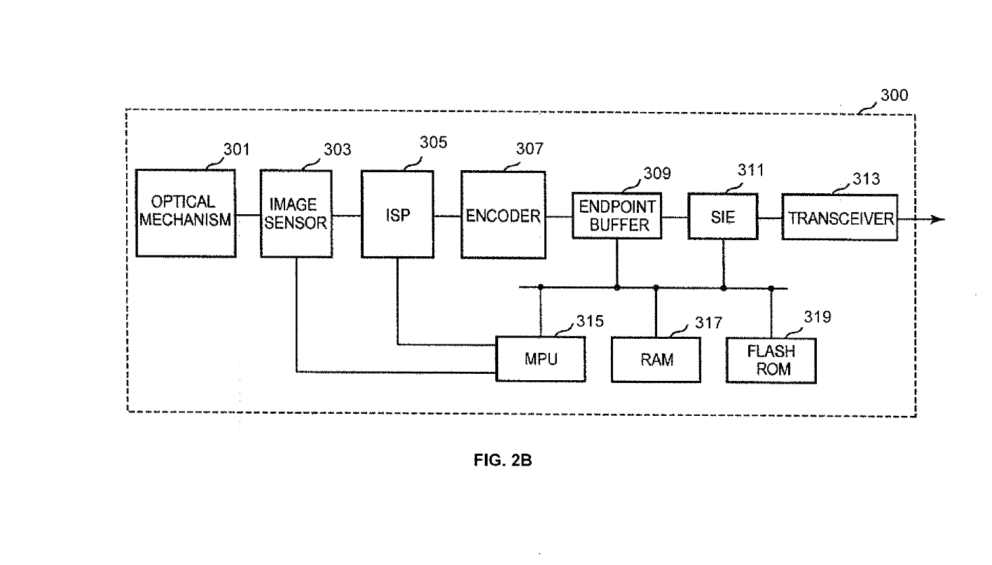

FIG. 2A illustrates a more detailed block diagram of the device 102 of FIG. 1 in accordance with embodiments herein. The device 102 includes one or more processors 104 (e.g., a microprocessor, microcomputer, application-specific integrated circuit, etc.), one or more local storage medium (also referred to as a memory portion) 106, GUI 108 which includes one or more input devices 209 and one or more output devices 210, the camera unit 110, GPS tracking circuit 120 and accelerometer 107. The device 102 also includes components such as one or more wireless transceivers 202, a power module 212, and a component interface 214. All of these components can be operatively coupled to one another, and can be in communication with one another, by way of one or more internal communication links 216, such as an internal bus.

The input and output devices 209, 210 may each include a variety of visual, audio, and/or mechanical devices. For example, the input devices 209 can include a visual input device such as a camera, an audio input device such as a microphone, and a mechanical input device such as a keyboard, keypad, hard and/or soft buttons, switch, touchpad, touch screen, icons on a touch screen, touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The GUI 108 permits the user to select one or more inputs to collect image information 218, enter candidate scene designation data 223, and/or enter indicators to direct the camera unit 110 to take a photo or video (e.g., capture image data for the scene 126), select attributes of interest, enter image ratings, select reference images for local storage and the like. As another example, the user may enter one or more predefined touch gestures through a touch sensitive screen and/or voice command through a microphone on the device 102. The predefined touch gestures and/or voice command may instruct the device 102 to collect image data for a scene and/or a select object (e.g. the person 222) in the scene and enter scene designation data.

The memory 106 also stores the candidate scene designation data 223.

The GUI 108 is configured to receive alphanumeric data entry, commands or instructions from the user to collect the image information 218. For example, in connection with a framing operation, the user may press (partially or fully) a hard or soft key on the GUI 108 to instruct the camera unit 110 to capture image information 218 that is less than a full resolution photograph. For example, a user may touch or partially depress the photo key, thereby directing the camera unit 110 to perform an auto-focus operation and to also capture image framing information. Alternatively or additionally, the GUI 108 may include a display that illustrates the scene within the field of view of the lens 114. The user may touch a region on the display where the object is located. In response, the camera unit 110 and/or processor 104 may collect image framing information for the scene.

The local storage medium 106 may encompass one or more memory devices of any of a variety of forms (e.g., read only memory, random access memory, static random access memory, dynamic random access memory, etc.) and can be used by the processor 104 to store and retrieve data. The data that is stored by the local storage medium 106 can include, but is not limited to, operating systems, applications, user collected content, image information, scene designation data and informational data. Each operating system includes executable code that controls basic functions of the device, such as interaction among the various components, communication with external devices via the wireless transceivers 202 and/or the component interface 214, and storage and retrieval of applications and data to and from the local storage medium 106. Each application includes executable code that utilizes an operating system to provide more specific functionality for the communication devices, such as file system service and handling of protected and unprotected data stored in the local storage medium 106.

The local storage medium 106 may store all or a portion of the collection 154 of reference images, including the metadata 157 associated with each of the reference images 156. The metadata 157 includes the reference scene designation data 158, the reference attributes of interest 160, image ratings 162 and ancillary content 164.

The local storage medium 106 stores a composition adjustment suggestion (CAS) application 224 for calculating AOI adjustments and facilitating collection of photographs and videos with the device 102 as explained herein. The CAS application 224 includes program instructions accessible by the one or more processors 104 to direct a processor 104 to implement the methods, processes and operations described herein including, but not limited to the methods, processes and operations illustrated in the FIGS. and described in connection with the figures.

The CAS application 224 directs the processor 104 to analyze the image information to derive one or more values for one or more attributes of interest. The values may represent a scale (e.g. 1-10) indicative of an extent to which the attribute of interest is satisfied. For example, on a scale of 1 to 10, a value of 7 may indicate above average balance, while a value of 3 may indicate below average balance. Additionally or alternatively, the value may be indicative of how the attribute of interest is misaligned. For example, a range of 1-10 may be applied to the rule of thirds, whereby a 1-3 indicates that the object is on the left portion of the field of view, and a 7-10 indicates that the object is on the right portion of the field of view.

Other applications stored in the local storage medium 106 include various application program interfaces (APIs), some of which provide links to/from the cloud hosting service. The power module 212 preferably includes a power supply, such as a battery, for providing power to the other components while enabling the device 102 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202 in conjunction with other components of the device 102 may take a variety of forms and may include, for example, operation in which, upon reception of wireless signals, the components of device 102 detect communication signals and the transceiver 202 demodulates the communication signals to recover incoming information, such as voice and/or data, transmitted by the wireless signals. After receiving the incoming information from the transceiver 202, the processor 104 formats the incoming information for the one or more output devices 210. Likewise, for transmission of wireless signals, the processor 104 formats outgoing information, which may or may not be activated by the input devices 210, and conveys the outgoing information to one or more of the wireless transceivers 202 for modulation to communication signals. The wireless transceiver(s) 202 convey the modulated signals to a remote device, such as a cell tower or a remote server (not shown).

Optionally, an accelerometer 107 may be provided to detect movement and orientation of the device 102. The movement and orientation may be used to monitor changes in the position of the device 102.

The camera unit 110 may include a video card 215, and a chip set 219. An LCD 217 (of the GUI 108) is connected to the video card 215. The chip set 219 includes a real time clock (RTC) and SATA, USB, PCI Express, and LPC controllers. A HDD is connected to the SATA controller. The camera unit 110 may include a USB controller 221 composed of a plurality of hubs constructing a USB host controller, a route hub, and an I/O port. The camera unit 110 may be a USB device compatible with the USB 2.0 standard or the USB 3.0 standard. The camera unit 110 is connected to the USB port of the USB controller 221 via one or three pairs of USB buses, which transfer data using a differential signal. The USB port, to which the camera unit 110 is connected, may share a hub with another USB device. Optionally, the USB port is connected to a dedicated hub of the camera unit 110 in order to effectively control the power of the camera unit 110 by using a selective suspend mechanism of the USB system. The camera unit 110 may be of an incorporation type in which it is incorporated into the housing of the note PC or may be of an external type in which it is connected to a USB connector attached to the housing of the note PC.

### Digital Camera Module

FIG. 2B is a functional block diagram illustrating a schematic configuration of a camera unit 300 that may be implemented as, or in place of, the camera unit 110 of FIG. 1 in accordance with embodiments herein. The camera unit 300 is able to transfer VGA (640×480), QVGA (320×240), WVGA (800×480), WQVGA (400×240), and other image data and candidate image information in the static image transfer mode. An optical mechanism 301 (corresponding to lens 114 in FIG. 1) includes an optical lens and an optical filter and provides an image of a subject on an image sensor 303.

The image sensor 303 includes a CMOS image sensor that converts electric charges, which correspond to the amount of light accumulated in photo diodes forming pixels, to electric signals and outputs the electric signals. The image sensor 303 further includes a CDS circuit that suppresses noise, an AGC circuit that adjusts gain, an AD converter circuit that converts an analog signal to a digital signal, and the like. The image sensor 303 outputs digital signals corresponding to the image of the subject. The image sensor 303 is able to generate image data at a select frame rate (e.g. 30 fps).

The CMOS image sensor is provided with an electronic shutter referred to as a “rolling shutter.” The rolling shutter controls exposure time so as to be optimal for a photographing environment with one or several lines as one block. In one frame period, or in the case of an interlace scan, the rolling shutter resets signal charges that have accumulated in the photo diodes, and which form the pixels during one field period, in the middle of photographing to control the time period during which light is accumulated corresponding to shutter speed. In the image sensor 303, a CCD image sensor may be used, instead of the CMOS image sensor.

An image signal processor (ISP) 305 is an image signal processing circuit which performs correction processing for correcting pixel defects and shading, white balance processing for correcting spectral characteristics of the image sensor 303 in tune with the human luminosity factor, interpolation processing for outputting general RGB data on the basis of signals in an RGB Bayer array, color correction processing for bringing the spectral characteristics of a color filter of the image sensor 303 close to ideal characteristics, and the like. The ISP 305 further performs contour correction processing for increasing the resolution feeling of a subject, gamma processing for correcting nonlinear input-output characteristics of the LCD, and the like. Optionally, the ISP 305 may perform the processing discussed herein to utilize the range information derived from the acoustic data to modify the image data to form 3-D image data sets. For example, the ISP 305 may combine image data, having two-dimensional position information in combination with pixel color information, with the acoustic data, having two-dimensional position information in combination with depth/range values (Z position information), to form a 3-D data frame having three-dimensional position information associated with color information for each image pixel. The ISP 305 may then store the 3-D image data sets in the RAM 317, flash ROM 319, local storage medium 106 (FIG. 1), storage medium 150 (FIG. 1), and elsewhere.

Optionally, additional features may be provided within the camera unit 300, such as described hereafter in connection with the encoder 307, endpoint buffer 309, SIE 311, transceiver 313 and micro-processing unit (MPU) 315. Optionally, the encoder 307, endpoint buffer 309, SIE 311, transceiver 313 and MPU 315 may be omitted entirely.

In accordance with certain embodiments, an encoder 307 is provided to compress image data received from the ISP 305. An endpoint buffer 309 forms a plurality of pipes for transferring USB data by temporarily storing data to be transferred bi-directionally to or from the system. A serial interface engine (SIE) 311 packetizes the image data received from the endpoint buffer 309 so as to be compatible with the USB standard and sends the packet to a transceiver 313 or analyzes the packet received from the transceiver 313 and sends a payload to an MPU 315. When the USB bus is in the idle state for a predetermined period of time or longer, the SIE 311 interrupts the MPU 315 in order to transition to a suspend state. The SIE 311 activates the suspended MPU 315 when the USB bus has resumed.

The transceiver 313 includes a transmitting transceiver and a receiving transceiver for USB communication. The MPU 315 runs enumeration for USB transfer and controls the operation of the camera unit 300 in order to perform photographing and to transfer image data. The camera unit 300 conforms to power management prescribed in the USB standard. When being interrupted by the SIE 311, the MPU 315 halts the internal clock and then makes the camera unit 300 transition to the suspend state as well as itself. The transceiver 313 may communicate overly wireless network and through the Internet with the server 150 (FIG. 1).

The server 150 includes one or more processors 151.

When the USB bus has resumed, the MPU 315 returns the camera unit 300 to the power-on state or the photographing state. The MPU 315 interprets the command received from the system and controls the operations of the respective units so as to transfer the image data in the dynamic image transfer mode or the static image transfer mode. When starting the transfer of the image data (and/or image framing information) in the static image transfer mode, the MPU 315 performs the calibration of rolling shutter exposure time (exposure amount), white balance, and the gain of the AGC circuit.

The MPU 315 performs the calibration of exposure time by calculating the average value of luminance signals in a photometric selection area on the basis of output signals of the CMOS image sensor and adjusting the parameter values so that the calculated luminance signal coincides with a target level. The MPU 315 also adjusts the gain of the AGC circuit when calibrating the exposure time. The MPU 315 performs the calibration of white balance by adjusting the balance of an RGB signal relative to a white subject that changes according to the color temperature of the subject. When AOI adjustments concern camera setting related attributes of interest, the MPU 315 may automatically adjust the camera setting related AOIs upon receiving the AOI adjustments.

The camera unit 300 is a bus-powered device that operates with power supplied from the USB bus. Note that, however, the camera unit 300 may be a self-powered device that operates with its own power. In the case of the self-powered device, the MPU 315 controls the self-supplied power to follow the state of the USB bus 50.

In accordance with embodiments herein, it is understood that the device 102 may a smart phone, a desktop computer, a laptop computer, a personal digital assistant, a tablet device, a stand-alone camera, a stand-alone video device, as well as other portable, stationary or desktop devices that include a lens and camera.

### Composition Adjustment Suggestion Process

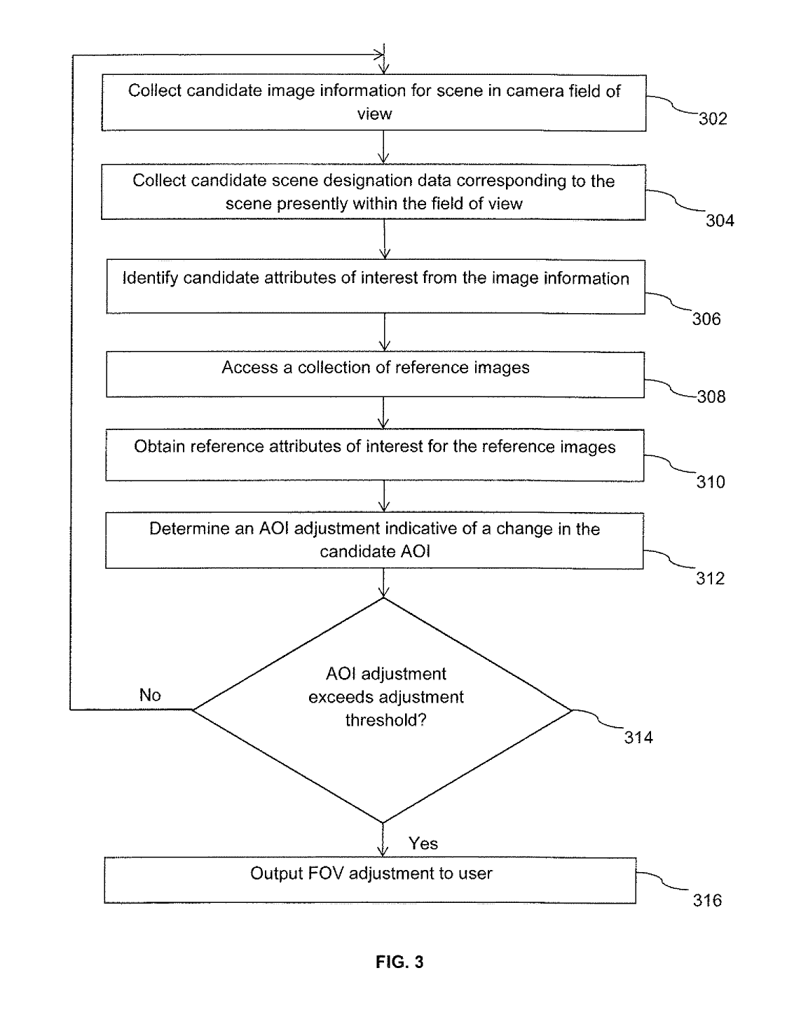

FIG. 3 illustrates a process carried out in accordance with embodiments for determining candidate or suggested adjustments to the composition of a photograph or video that has been taken or is being framed and is about to be taken. The operations of FIG. 3 are carried out by one or more processors 104 of the device 102 in response to execution of program instructions, such as in the CAS application 224, and/or other applications stored in the memory 106. Additionally or alternatively, the operations of FIG. 3 may be carried out in whole or in part by processors of the server 150.

At 302, the process collects image information 218, also referred to as candidate image information, for a scene in the field of view (FOV) of the device 102 under user control, such as at camera unit 110. The candidate image information 218 may represent a photograph or video recording at a full resolution capability of the camera unit 110. Optionally, the candidate image information 218 may represent image framing information that constitutes one or more portions of a photograph and/or video recording, at full or reduced resolution. The image information 218 is collected automatically by the camera unit 110 or under user control through the GUI 108. The image information 218 is saved in the local storage medium 106. Additionally or alternatively, the image information 218 may be conveyed over a network (e.g., the Internet) wirelessly to the server 150 and saved in the storage medium 150 at the server 150.

The image information 218 may constitute a full resolution image for the entire region of the scene in the field of view. Optionally, the image information 218 may constitute less content than a full resolution image. For example, the image information 218 may constitute image framing information associated with and defined by at least one of i) a select region of the scene in the field of view or ii) a reduced or restricted resolution image of the scene in the field of view. As an example, the image framing information may be limited to a select region in the middle of the scene, a select region chosen by the user through the GUI 108, a select region that is automatically chosen by the processor 104 (e.g., during a focusing operation) and the like. When the image framing information constitutes a reduced or restricted resolution image, the image framing information may be a low resolution image such as 50%, 75%, 85% or some other percentage resolution of the full resolution capability of the camera unit 110. Alternatively or additionally, a combination of a restricted resolution image and a select region may be used to form the image framing information.

The camera unit 110 may collect the image information 218 automatically, such as every time the camera unit 110 performs an auto-focus operation. Optionally, the camera unit 110 may collect the image information 218 periodically (e.g., every few seconds) once the camera unit 110 is activated (e.g., turned on or the photography/video application is opened on the device 102). The camera unit 110 may collect image information in response to a lack of physical movement of the device 102, such as when the accelerometer 107 measures the device 102 is held at a particular position/orientation stationary for a few seconds. Additionally or alternatively, the camera unit 110 may collect image information 218 in response to an input from the user at the GUI 108. For example, the user may touch a key or speak a command to direct the camera unit 110 to collect the image framing information. For example, a separate “framing” key may be presented on the GUI 108. Optionally, the photograph or record key may also be configured to have a dual function, such as a first function to instruct the camera unit 110 to take photographs and/or recordings when fully pressed or pressed for a select first period of time. The second function may instruct the camera unit 110 to collect the image information 218 when pressed partially less than a full amount. Alternatively or additionally, the second function may be triggered by setting a different “activation time” for the key, such that when the photograph or record key is temporarily touches for a short period of time or held for an extended period of time, such actions are interpreted as instructions to collect image framing information (and not simply to capture a full resolution image of the entire scene in the field of view).

At 304, the process collects scene designation data 222, also referred to as candidate scene designation data, that uniquely identifies the scene presently within the field of view of the mobile device. For example, the GPS tracking circuit 120 may collect GPS coordinate as the candidate scene designation data, where the GPS coordinate data corresponds to the location of the device 102. The candidate scene designation data 222 is saved in the local storage medium 106 (and/or in the storage medium 150 of the server 150). By way of example, the candidate scene designation data 158 may comprise one or more of location data, time and date data, and/or landmark identification data. As an example, the location data may correspond to the geographic coordinates of the device 102, as well as the time and date at which the image information 218 is collected.

Alternatively or additionally, the scene designation data 158 may include landmark identification data, such as a name of an object in the scene (e.g. the Eiffel tower, the Statue of Liberty, etc.), a name of the overall scene (e.g. the Grand Canyon as viewed from the South rim, the Grand Canyon as viewed from the West entrance, Niagara Falls, etc.) and the like. The landmark identification data and/or name of the object or overall scene may be entered by the user through the GUI 108. Alternatively or additionally, the landmark identification data and/or name of the object or overall scene may be determined automatically by the processor 104. For example, the processor 104 may perform image analysis of objects in the image information 218 collected by the camera unit 110 to determine the landmark identification data and names. Optionally, the image analysis may compare the image information 218 to a group of templates or models to identify the scene as a building, mountain, landmark, etc. Alternatively or additionally, the processor 104 may analyze location related information (e.g. GPS coordinates, direction and orientation of the device 102) collected by the device 102 to identify the landmark identification data and/or names. As another example of location related information and/or candidate scene designation data, the processor 104 may analyze network related identifiers, such as cellular tower identifiers, cellular network identifiers, wireless network identifiers, and the like, such as to determine that the mobile device is located near Sears Tower in Chicago, near the Washington Monument in Washington D.C., near the Golden gate Bridge in San Francisco or otherwise.

Alternatively or additionally, the scene designation data may be entered by the user through the GUI 108. For example, the process may receive, through the GUI 108, a user entered indicator (e.g., address, coordinates, name, etc.) designating the scene in the field of view in connection with collecting the image information 218.

At 306, the process identifies candidate attributes of interest from the image information 218. For example, the processor 104 and/or camera unit 110 may identify the candidate attributes of interest by performing image processing on the image information 218. The candidate attributes of interest may represent one or more camera setting-related attributes of interest and/or one or more composition-related attributes of interest. For example, the processor 104 and/or the server 150 may analyze the image information 218 captured by the camera unit 110 to identify values for one or more compositional constructions or rules, such as the rule of thirds, the golden ratio, golden triangle, golden spiral, rule of odds, leaving space, fill the frame, simplification, balance, leading lines, patterns, color, texture, symmetry, viewpoint, background, depth, framing, orientation, contrast, layout, arrangement and the like. The processor 104 and/or the server 150 may derive, as the value for the candidate attribute of interest, a numeric rank or scaled value for each attribute of interest. For example, the processor 104 and/or the server 150 may determine a scale between 1 and 10, a high/medium/low rank, etc. indicative of a degree to which the scene satisfies the rule of thirds, a degree to which the scene is balanced, a degree to which the scene is symmetric, whether the scene is framed in portrait or landscape, an extent or range of the colors, layout or texture present in the scene, and the like. Alternatively or additionally, the processor 104 and/or the server 150 may also determine the camera related settings associated with the camera unit 110, such as the shutter speed, aperture size and the like. The candidate attributes of interest are saved in local storage medium 106 and/or passed to the server 150 and saved in storage medium 150.

At 308, the process accesses a collection 154 of reference images 156 and obtains one or more reference images 156 that have reference scene designation data 158 matching the candidate scene designation data collected at 304. For example, the device 102 may send a request to the server 150 for reference images. The device 102 may also send user identification information, the candidate scene designation data, the attributes of interest and the like. Optionally, when the reference images are stored locally in the device 102, the processor 104 accesses the local storage medium 106.

With reference to FIG. 1, the server 150 or processor 104 may utilize GPS coordinates collected by the GPS tracking circuit 120 (or other geographic location information) as candidate scene designation data to search through the metadata 157 within the collection 154 of reference images 156. Reference images 156 are identified that have reference scene designation data 158 that matches, or is within a common region, as the present candidate GPS coordinates of the device 102. For example, when the present candidate scene designation data represents GPS coordinates proximate to the Statue of Liberty, the process identifies at 308 one or more reference images concerning the Statue of Liberty. Optionally, at 308, the process may identify a subset of the reference images of the landmark, such as the reference images taken from a common side or general region, such as when the scene designation data corresponds to a large landmark (e.g. the Grand Canyon) or other object that is relatively large, such that it is difficult for a user to move to an opposite side or substantially different view point. For example, when taking photographs of the Grand Canyon from the South rim, at 308, reference images may be selected that represent photographs or video of the Grand Canyon from various viewpoints along the South rim.

Alternatively or additionally, the reference images 156 may be identified as relevant or non-relevant to the image information 218 based on whether the reference scene designation data 158 is located within a predetermined range from, or boundary surrounding, the present candidate scene designation data 222 of the image information 218. For example, when the present candidate scene designation data 222 identifies a GPS coordinate or a corner of an intersection in downtown Chicago, the process may exclude reference images that have reference scene designation data 158 more than a select distance (e.g., 20 feet, one block, on the opposite side of the street, etc.) away from the corner or intersection.

After the reference images 156 of interest are identified, at 310, the process obtains the values for the attributes of interest 160 from the metadata 157 of the reference images 156 identified at 308. The attributes of interest may be designated by the user, such as during a set up operation for the camera unit 110. Alternatively, the attributes of interest may represent predetermined system parameters designated on the server 150 by a system manager and the like. For example, the user may indicate (during set up of the camera unit 110) an interest to view reference images 156 having a desired lighting and/or viewpoints. In this example, the process would obtain the values for the lighting and the designation of the view point as the attributes of interest. Alternatively or additionally, other attributes of interest may be designated or within the metadata 157 of the reference images. These additional attributes of interest may be presented to the user as suggestions for adjustments. For example, when the user may be primarily interested in achieving a desired lighting, a system level suggestion may be provided to the user to adjust the layout of the objects within the field of view, change from portrait to landscape orientation and the like.

When the reference attributes of interest are determined at the server 150, the reference attributes of interest are passed back to the device 102, such as over a network.

At 312, the process determines an AOI adjustment indicative of a change in the candidate AOI in order to align the candidate AOI with the reference AOI. The AOI adjustment may be determined by comparing the candidate and reference AOIs. The AOI adjustment may be determined based on a difference between the candidate and reference AOIs. For example, when the candidate AOI and reference AOI correspond to viewpoint, the AOI adjustment may be indicative of a distance and direction in which it is suggested to move the device 102 to align the device 102 with the viewpoint from which a corresponding reference image was taken. The movement may simply represent tilting the field of view up or down, left or right. As another example, the movement may represent moving the device 102 closer toward, or further away from, an object in the scene, and/or moving the device 102 several feet left or right. As another example, the change indicated by the AOI adjustment may factor in, or be based at least in part on at least one of i) a time of day when the image information was collected, ii) shadows that appear within the scene, or iii) a season when the image information was collected. For example, when the candidate AOI and reference AOI correspond to lighting, the AOI adjustment may indicate a time of day (or season of the year) at which it may be desirable to capture photographs or record video of the scene in order to achieve composition lighting associated with the corresponding reference image. When harsh shadows are detected as present within the image information, the AOI suggestion may be to wait a few minutes until a cloud passes over, or when excessive cloud cover is present, the suggestion may be to take the picture at another time when the sun is out. As another example, when the candidate AOI and reference AOI correspond to camera settings (e.g. shutter speed or aperture size), the AOI adjustment may indicate the change in the camera setting that may be desirable in order to capture images similar to the corresponding reference image.

At 314, the process determines whether the AOI adjustment exceeds an adjustment threshold, and thus warrants presentation to the user as a suggestion. For example, the user may not want suggestions with every photograph or video recording. Accordingly, an adjustment threshold may be set by the user and/or preset at the time of manufacture or calibration, such that suggestions in AOI adjustments are presented to the user when the AOI adjustments are sufficient to exceed the threshold. Optionally, the operation at 314 may be entirely omitted, such as when it is desired to provide AOI adjustments to the user in connection with all photographs and video recordings. When the AOI adjustment does not exceed the adjustment threshold, flow returns to 302. Otherwise flow continues to 316. The change indicated by the AOI adjustment may be based at least in part on at least one of i) a time of day when the image information was collected, ii) shadows that appear within the scene, or iii) a season when the image information was collected.

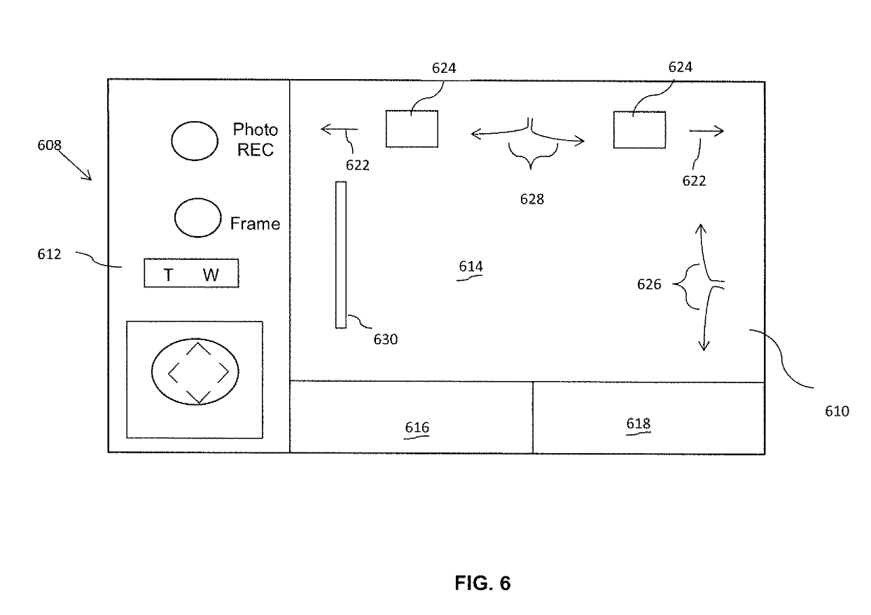

At 316, the process outputs the AOI adjustment to user. The AOI adjustment may be output to the user in various manners, such as described in connection with FIG. 6. For example, the AOI adjustment may be presented as one or more indicia presented on a display 108 of the device 102. For example, the indicia may represent a text message providing the suggested AOI adjustment. Additionally or alternatively, the indicia may represent graphical characters, numerals, highlighting, arrows, and the like. As an example, when the AOI adjustment suggests to move the viewpoint to a left or right, up or down, an arrow may be presented along the corresponding left, right, top or bottom edge of the display indicating to the user a suggestion to turn to the left or right, tilt the field of view up or down, or physically walk X feet in a corresponding direction. For example, the AOI adjustment may represent an instruction to the user to move the field of view of the camera at least one of i) left, ii) right, iii) aim higher, iv) aim lower, v) closer, vi) farther away, and vii) up, viii) down, ix) zoom in, x) zoom out, xi) aim left, xii) aim right relative to a position of the camera after the image information was collected. Additionally or alternatively, the AOI adjustment may be presented as an audible message played from a speaker in the device 102.

Additionally or alternatively, when the AOI adjustment corresponds to a camera setting related AOI, the camera unit 110 may automatically implement the AOI adjustment (e.g. automatically change the aperture size, shutter speed and the like).

Optionally, the order of operations shown in FIG. 3 may be changed. For example, the operations at 306 may precede 304, and/or the operations at 310 may precede 308, etc.

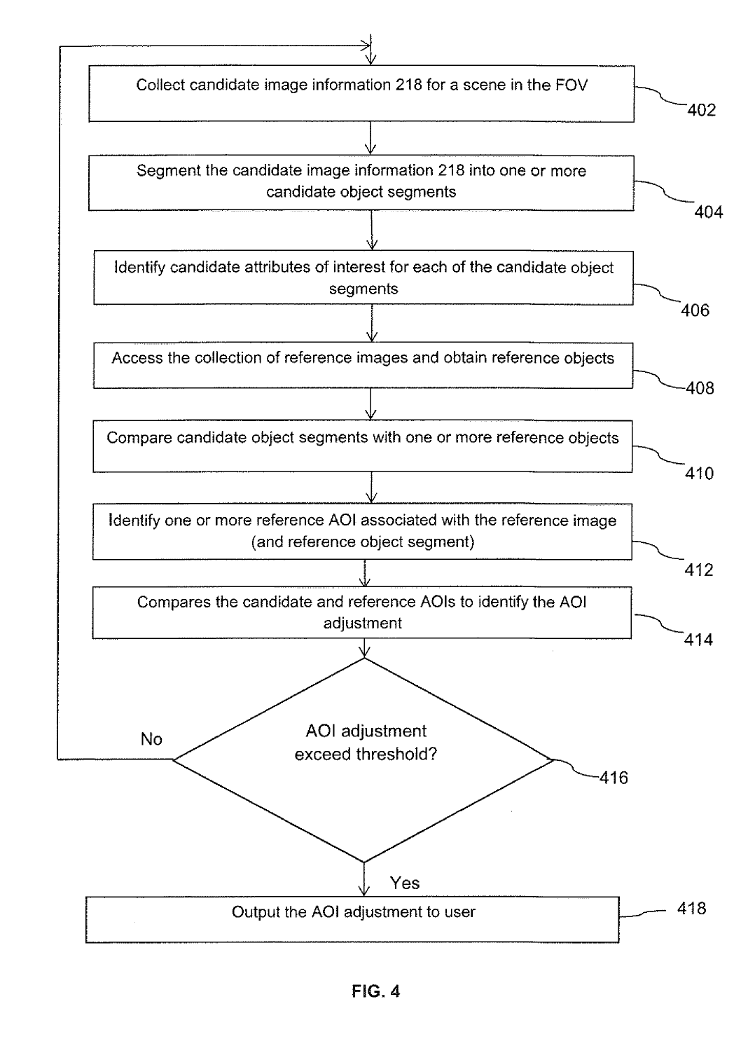

FIG. 4 illustrates a process for determining candidate or suggested adjustments based on image analysis in accordance with embodiments herein. The operations of FIG. 4 are carried out by one or more processors 104 of the device 102 in response to execution of program instructions, such as in the CAS application 224, and/or other applications stored in the local storage medium 106. The operations of FIG. 4 may also be carried out in whole, or in part, by the server 150.

At 402, the process collects candidate image information 218 for a scene in the FOV of the device 102 under user control.

At 404, the process segments the candidate image information 218 into one or more candidate object segments. For example, various image analysis techniques may be implemented to separate one or more objects in the candidate image information 218. For example, when taking photographs of people with a landmark object in the background, the image analysis may segment the people separate from the landmark object. As another example, the candidate image information 218 may be segmented in connection with identifying lighting, shadows, season, time of day and the like. For example, the segmentation may seek to identify regions of cloudy sky, shadows around objects in the scene, snow regions in the background, regions of clear sky and the like.

At 406, the process identifies candidate attributes of interest for each of the candidate object segments. Thus, if a mountain appears in the background, the mountain would be identified as a candidate object segment, and one or more candidate AOI identified. As another example, the candidate object segments may be analyzed to identify lighting, shadows, season, time of day and the like. For example, the image analysis may seek to identify regions of cloudy sky, shadows around objects in the scene, snow regions in the background, regions of clear sky and the like, in order to factor in the time of day, season, shadows and the like into the AOI adjustment.

At 408, the process accesses the collection 154 of reference images 156 in memory and obtains, from the collection 154 of reference images 156, reference objects that match the candidate object segments. For example, each reference image 156 may include one or more landmarks or other well-known objects.

At 410, the process compares the candidate object segments from the image information 218 collected at 402 with one or more reference objects from one or more reference images 156. For example, the comparison may utilize various image analysis techniques such as image correlation, key point matching, feature histogram comparison, image subtraction and the like. Each comparison of the candidate object segments from the image information 218 with reference object segments is assigned a correlation rating that indicates a similarity or difference between the candidate object segments and the reference object segments. When more than one reference object segment generally matches the candidate object segment(s), the reference object segment having a select correlation rating (e.g. closest, best) is chosen and the corresponding reference image is utilized to determine the reference AOIs. For example, the comparison may compare regions of the sky in the candidate object segment with sky related reference objects to determine whether the candidate object segment corresponds to a sunny day, a cloudy day, a partially cloudy day or the like. The comparison may compare candidate and reference object segments to determine the time of day, whether the candidate object segment includes snow, rain and the like.

As an example, when a mountain is identified as the candidate object segment, the process identifies reference object segments that represent mountains. Optionally, the reference object segments may be identified in whole or in part based on scene designation data. For example, candidate and reference scene designation data may be matched first to yield a subset of reference object segments (or reference images). Next, the reference images (or reference object segments) in the subset are compared through image analysis to the candidate object segment. For example, the comparison may be performed to identify reference images from a common side of a landmark as the candidate image information, such as when the scene designation data are general to an area and not a specific GPS coordinate.

At 412, the process identifies one or more reference AOI associated with the reference image (and reference object segment) identified at 410, similar to the process discussed above in connection with FIG. 3. For example, when the candidate object segment corresponds to a sunny day, a cloudy day, a partially cloudy day or the like, the process may identify a reference AOI appropriate thereto. For example, when the reference AOI includes one or more camera settings, the appropriate camera settings may be selected based on an amount of cloud cover, an amount or harshness of shadows, etc. When the candidate object segment includes snow, rain and the like, the process may similarly identify a reference AOI appropriate for the conditions detected in the candidate object segment.

At 414, the process compares the candidate and reference AOIs to identify the AOI adjustment similar to the process discussed above in connection with FIG. 3. As noted above, the change indicated by the AOI adjustment may factor in, or be based at least in part on at least one of i) a time of day when the image information was collected, ii) shadows that appear within the scene, or iii) a season when the image information was collected. For example, the segmentation and identifying operations as 404 and 406 may relate at least in part to determining a lighting within the scene. When lighting represents a candidate AOI and reference AOI, at least one AOI adjustment may indicate a time of day (or season of the year) at which it may be desirable to capture photographs or record video of the scene in order to achieve composition lighting associated with the corresponding reference image. When harsh shadows are detected at 404 and 406 to be present within the image information, the AOI suggestion may be to wait a few minutes until a cloud passes over. Additionally or alternatively, when the shadows detected at 404 and 406 indicate excessive cloud cover to be present, the suggestion may be to take the picture at another time when the weather is sunny.

At 416, the process determines whether the AOI adjustment exceeds an adjustment threshold, and thus warrants presentation to the user as a suggestion. While not shown, optionally, after 416, the process determines whether the AOI adjustment exceeds an adjustment threshold, and thus warrants presentation to the user as a suggestion. When the AOI adjustment does not exceed the adjustment threshold, flow returns to 402. Otherwise flow continues to 418.

At 418, the process outputs the AOI adjustment to user.

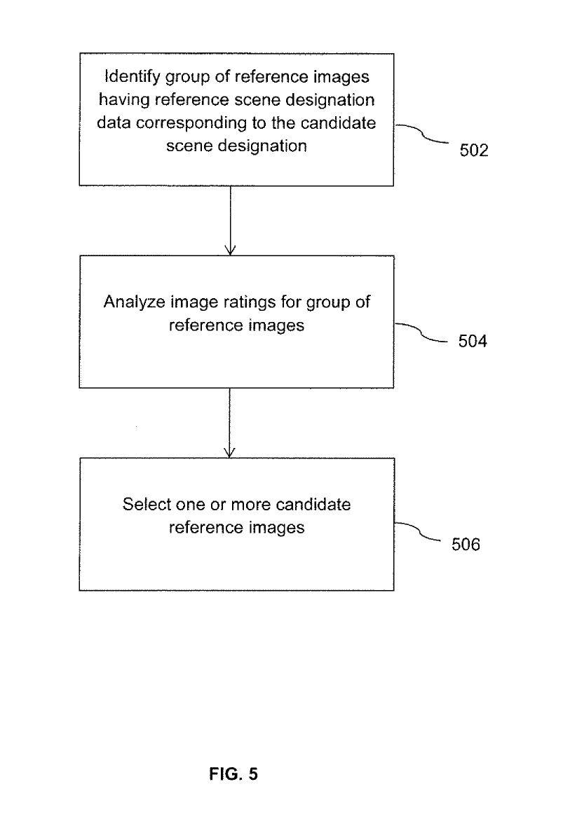

FIG. 5 illustrates a process to identify a subset of reference images from a collection of the reference images based on image ratings in accordance with embodiments herein. The operations of FIG. 5 may be carried out by one or more processors 104 of the device 102 in response to execution of program instructions, such as in the CAS application 224, such as when the collection of reference images are stored in the memory 106. The operations of FIG. 5 may be carried out in whole or in part by processors of the server 150, such as when the collection of reference images are stored remote from the device 102 (e.g. at the server 150 or at another data storage location).

At 502, the process identifies, from the collection of reference images, the group of reference images that have reference scene designation data that corresponds to the candidate scene designation data collected in connection with the candidate image information (as discussed in connection with FIG. 3). The reference scene designation data may be determined to “correspond” when the reference scene designation data is within a predetermined range of the candidate scene designation (e.g. 3 feet, 30 feet, 10 miles, etc.). Additionally or alternatively, the reference scene designation data may be determined to “correspond” when the reference scene designation data is within a predetermined boundary for a region associated with the candidate scene designation data (e.g. on Ellis Island, in the loop of Chicago, in Estes National Park, at the Grand Canyon).

At 504, the process analyzes the image ratings associated with the reference images within the group identified at 502. As noted herein in connection with FIG. 1, each reference image 156 may have a corresponding image rating 162 (FIG. 1) saved in the metadata 157 of the reference image 156. The image ratings 162 may be indicative of various characteristics of the corresponding reference image. For example, the image rating 162 may indicate an overall likability by viewers, an assessment by professional photographers, image quality and the like. The image rating 162 may also be derived from feedback from users of the embodiments herein, where the image rating reflects the usefulness of an AOI adjustment suggested based on the corresponding reference image 156. For example, a user of the device 102 may be afforded an opportunity to provide feedback to the server 150. The feedback may indicate a degree to which the user likes the chosen reference image. The feedback may also indicate a degree to which the reference image (and associated reference AOI) provided a useful suggestion as an AOI adjustment. For example, an AOI adjustment may suggest that a user move 30 feet in a particular direction, however a bridge, wall, fence or other barrier may prevent the user from making the suggested AOI adjustment. As another example, the AOI adjustment may suggest that a user wait until dusk before taking the photograph, however other activity (e.g. road construction, rush-hour) in the surrounding area may begin at dusk (that did not exist at the date/time that the reference image was taken).

When AOI adjustments are suggested that are not practical, the user may enter feedback, at the device 102 (or on another computing device), where the feedback indicates a level of usefulness of the AOI adjustment. For example, an image rating of 1 or 2 may be provided for AOI adjustments that were not practical or useful suggestions, while an image rating of 9 or 10 may be provided for AOI adjustments that were found very helpful and easily implemented by the user of the device 102.

The image ratings 162 may be entered at the time that the reference images 156 are saved, such as by a system or database manager or the photographer taking the reference images 156. Additionally or alternatively, the image ratings 162 may be entered by viewers (e.g. amateur or professional) who review the reference images and provide feedback including image ratings. When more than one source of image rating feedback is provided for an individual reference image, the multiple image ratings may be combined (e.g. averaged, the mean, mode, etc.) and saved as the image rating 162. Additionally or alternatively, the image ratings may be continuously updated through feedback from viewers, including feedback from users of the embodiments herein.

Additionally or alternatively, reference images may have image rating associated with different attributes of interest for the reference image. For example, a single reference image may have an image rating of nine in connection with viewpoint, but an image rating of two with respect to balance or symmetry. When individual reference images include multiple image rating, the analysis at 504 may combine the image ratings, such as through a weighted average, an even average, or some other statistical combination to derive an overall image rating for the single reference image. The analysis at 504 may output an ordered list of reference images ordered from the reference image having the highest image rating to the reference image having the lowest image rating.

At 506, the process selects one or more of the reference images output at 504 to be candidate reference images. For example, at 506, the candidate reference images may include all of the reference images output from the analysis at 504. Optionally, the selection at 506 may output a portion of the group of reference images that have image ratings below a predetermined threshold. Optionally, the selection at 506 may output a portion of the group of reference images that have image ratings above a predetermined threshold. The reference images selected at 506 are used as the candidate reference images, from which one or more reference image is chosen based on the comparison of the candidate and reference scene designation data.

FIG. 6 illustrates a user interface 608 that may be implemented on the device 102 in accordance with embodiments herein. The user interface 608 may be entirely or only partially touch sensitive. The user interface 608 generally includes an input area 612 and a display area 610. The input area 612 may include one or more buttons, softkeys, switches and the like, to receive inputs from the user in connection with carrying out various operations supported by the device 102.

The display area 610 includes a scene window 614. The scene window 614 displays the scene visible in the field of view of the lens 114 (FIG. 1). Optionally, an attribute window 616 and/or a camera setting window 618 may be presented in the display area 610. The attribute window 616 may display indicia indicative of attributes of interest, while the camera setting window 618 may display indicia indicative of present camera settings. The indicia presented in the attribute and camera setting windows 616 and 618 may be alphanumeric, graphical, color-coded, animated and the like. By way of example, the attribute window 616 may display names and/or values for attributes of interest. The attribute window 616 may display names and values for candidate attributes of interest and/or reference attributes of interest. Optionally, the candidate attributes of interest may not be displayed, but instead the reference attributes of interest may be displayed in the attribute window 616.

For example, when image framing information is analyzed (as discussed herein) to determine candidate attributes of interest, the value for the candidate attributes of interest may be presented in the attribute window 616. The candidate attributes of interest displayed in attribute window 616 may be provided for informational purposes. Optionally, the user may be afforded, through the input area 612, the opportunity to accept or reject the value for the attribute of interest. When the user rejects a value for an attribute of interest, the user may request, through the input area 612, suggestions for an AOI adjustment to improve the value for the attribute of interest. In response to a request for AOI adjustment, the processes discussed herein are implemented to determine AOI adjustments to suggest. Optionally, the process to calculate AOI adjustments as discussed herein is implemented automatically without input from the user.

The scene window 614 may present indicia indicative of the AOI adjustments output from the processes discussed herein. The indicia may be alphanumeric, graphical or otherwise. For example, when the AOI adjustment suggests to move to a different viewpoint, left/right arrow indicia 622 may be displayed to indicate the direction to move. Alternatively or additionally, alphanumeric indicia 624 may be presented next to the left/right arrow indicia 622 to indicate a suggested distance to move. Additionally or alternatively, rotate up/down arrow indicia 626 may be displayed when suggesting to adjust the tilt of the camera up or down. Additionally or alternatively left/right pivot indicia 628 may be displayed when suggesting to pivot or rotate the camera to the left or right, without laterally translating/moving in the left or right directions.

Optionally, the arrow indicia 622 and 628 may be replaced or supplemented with graphics, such as color-coded bars 630 along an edge of the scene window 614. A color-coded bar 630 may be highlighted to indicate a suggestion or instruction to move in a corresponding direction. The color of the bar 630 may correspond to an amount of movement suggested or instruction. For example, the bar 630 may be illustrated along the left side of the display to indicate a suggestion to move to the left. The bar 630 may be illustrated in yellow to indicate that a slight movement is suggested, in orange to indicate that a large movement is suggested, in green to indicate that movement should be stopped as the AOI adjustment has been made. Optionally, the bar 630 may be illustrated in red to indicate that too much movement has occurred and that the device 102 has been moving too far. Similarly, bars may be presented on the right side, top and/or bottom of the scene window 614, for which the colors are managed in a similar manner to output AOI adjustment suggestions.

Additionally or alternatively, alphanumeric text may be presented on the scene window 614 as output of the AOI adjustment. The following are examples of messages that may be displayed as text or audibly spoken through a speaker of the device 102: “move left 5 feet”, “move right 10 yards”, “step back 10 feet”, “tilt the camera up more”, “position the Statute of Liberty on right third of display”, “center people in display”, “rotate camera up/down until sunset is in top third of display”.

The above examples for the display format, display content, indicia and the like are not to be construed as limited. It is recognized that numerous other display formats, display content, and indicia may be used to output AOI adjustment suggestions. It is recognized that the indicia may be formatted in various manners and presented without or outside the scene window 614.

In accordance with at least one embodiment herein, to the extent that mobile devices are discussed herein, it should be understood that they can represent a very wide range of devices, applicable to a very wide range of settings. Thus, by way of illustrative and non-restrictive examples, such devices and/or settings can include mobile telephones, tablet computers, and other portable computers such as portable laptop computers.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, etc. or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the FIGs., which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying FIGs., it is to be understood that this description is not limiting and that various other changes and modifications may be affected therein by one skilled in the art without departing from the scope or spirit of the disclosure.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
collecting image information for a scene in a field of view with a camera;
obtaining a candidate attribute of interest (AOI) associated with the image information;
identifying a reference AOI associated with a reference image corresponding to the image information;
determining an AOI adjustment indicative of a change in the candidate AOI in order to align the candidate AOI with the reference AOI; and
outputting the AOI adjustment.

2. The method of claim 1, wherein the AOI adjustment is determined based on a difference between the candidate and reference AOIs.

3. The method of claim 1, further comprising collecting scene designation data uniquely identifying the scene, the reference AOI identified based on the scene designation data.

4. The method of claim 3, wherein the scene designation data constitutes metadata collected by the mobile device and saved with the image information, and wherein the scene designation data comprises at least one of location data, date and time data, or landmark identification data.

5. The method of claim 3, wherein the AOI adjustment represents an instruction to move the field of view of the camera at least one of i) left, ii) right, iii) aim higher, iv) aim lower, v) closer, vi) farther away, and vii) up, viii) down, ix) zoom in, x) zoom out, xi) aim left, xii) aim right, relative to a position of the camera after the image information was collected.

6. The method of claim 1, wherein the image information includes scene designation data uniquely identifying the scene corresponding to the image information, the identifying further comprising identifying the reference image from a collection of reference images based on scene designation data.

7. The method of claim 1, wherein the AOI adjustment corresponds to an adjustment for at least one of a rule of thirds, golden ratio, golden triangle, golden spiral, rule of odds, leaving space, fill the frame, simplification, balance, leading lines, patterns, color, texture, symmetry, viewpoint, background, depth, framing, orientation, contrast, layout, arrangement, image composition, view point, lighting, and camera settings.

8. The method of claim 1, wherein the obtaining includes analyzing the image information to obtain the candidate AOI, and wherein the change indicated by the AOI adjustment is based at least in part on at least one of i) a time of day when the image information was collected, ii) shadows that appear within the scene, and iii) a season when the image information was collected.

9. A computer program product comprising a non-signal computer readable storage medium comprising computer executable code to perform:
collecting image information for a scene in a field of view with a camera;
obtaining a candidate attribute of interest (AOI) associated with the image information;
identifying a reference AOI associated with a reference image corresponding to the image information;
determining an AOI adjustment indicative of a change in the candidate AOI in order to align the candidate AOI with the reference AOI; and
outputting the AOI adjustment.

10. The computer program product of claim 9, wherein the analyzing includes segmenting the image information into one or more segmented objects and identifying one or more candidate attributes of interest associated with each of the one or more segmented objects.

11. The computer program product of claim 9, wherein the code further performs: accessing a collection of reference images, comparing reference segmented objects in the reference images with the segmented objects from the image information to identify one or more of the reference images related to the image information.

12. The computer program product of claim 9, wherein the identifying includes comparing the candidate and reference AOIs to identify the AOI adjustment.

13. The computer program product of claim 9, wherein the image information includes scene designation data uniquely identifying the scene corresponding to the image information, the identifying further comprising identifying the reference image from a collection of reference images based on scene designation data.

14. A system, comprising:
a processor;
a camera to collect image information for a scene in a field of view of the camera; and
a storage medium storing program instructions accessible by the processor;
wherein, responsive to execution of the program instructions, the processor:
obtains a candidate attribute of interest (AOI) associated with the image information;
receives a reference AOI associated with a reference image corresponding to the image information; and
determines an AOI adjustment indicative of a change in the candidate AOI in order to align the candidate AOI with the reference AOI; and
a user interface to output the AOI adjustment.

15. The device of claim 14, wherein the camera unit obtains, as the image information, image framing information representing at least one of i) a select region of the scene in the field of view and ii) a restricted resolution image of the scene in the field of view.

16. The system of claim 14, wherein the processor determines the AOI adjustment based on a difference between the candidate and reference AOIs.

17. The system of claim 14, further comprising a GPS tracking circuit to collect scene designation data uniquely identifying the scene, the reference AOI identified based on the scene designation data.

18. The system of claim 17, wherein the storage medium saves the scene designation data as metadata associated with the image information.

19. The system of claim 17, further comprising a server and a storage medium located remote from the camera, the storage medium storing a collection of reference images, the camera to collect scene designation data, the server to identify the reference image from the collection of reference images based on the scene designation data.

20. The system of claim 14, wherein the storage medium includes a local storage medium and the local storage medium, camera, processor and user interface are provided in a portable handheld device.
